(19) United States
(12) Patent Application Publication
(10) Pub. No.: US 2008/0250251 A1
(43) Pub. Date: Oct. 9, 2008

(54) Systems and Methods for Hardware Driven Program Execution

(75) Inventors: Hung-Te Lin, Taipei City (TW); Chih-Chung Chang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CYBERLINK CORP., Shindian City (TW)

(21) Appl. No.: 11/696,431

(22) Filed: Apr. 4, 2007

(51) Int. Cl. G06F 12/14

(52) U.S. Cl. 713/189

(57) ABSTRACT

Systems and methods for storing and accessing encrypted content are described. At least one embodiment includes a system for storing and accessing encrypted content comprising a secure hardware device coupled to a memory comprising a trusted module, wherein the hardware device is configured to receive content from a remote location, and wherein the hardware device is configured to encrypt content and generate a key for decrypting the content. The system further comprises logic stored within the memory configured to access the encrypted content, wherein the logic comprises a plurality of decryption modules and at least one decoder.

### TECHNICAL FIELD

The present disclosure generally relates to data encryption and more particularly relates to a system for storing and accessing encrypted content through a combination of hardware and software.

### BACKGROUND

Over the years, digital video content has gained increasing popularity with consumers. With the increasing amount of audio and video content available to consumers through broadcast, cable, on-demand, fixed media, and other available sources of multimedia content, consumers have easy access to an increasing amount of content and programming. Furthermore, many devices (e.g., PCs, DVD recorders) and services that are readily available allow consumers to record, time-shift or view on-demand video and audio content. Furthermore, an increasing amount of video content is becoming available over the Internet and other data services in the form of downloadable content such as IPTV (Internet Protocol Television) delivered video services.

Generally, video content can be stored in any number of common formats such as MPEG-1, MPEG-2, or DV (digital video), for example. Likewise, audio content may be stored in any number of common digital formats such as MP3, WAV, or MPEG Audio, for example. The availability of multimedia content in a vast array of digital formats has helped make distribution of multimedia content easier because of the high degree of portability. Unfortunately, piracy of audio/visual works has also proliferated over the years as technology continues to facilitate the distribution of multimedia content. Because of the ease in accessing and copying multimedia content over the Internet for example, video and audio piracy continues to be an ongoing problem.

In response to unauthorized copying and distribution of multimedia content, publishers and authors of audio/visual works have relied on technologies that control access to digital content. The term Digital Rights Management (DRM) generally describes technologies used to achieve restricted access to multimedia content. Such DRM technologies are based on a large variety of technologies, including multimedia player software that control access to content using encryption. However, one apparent shortcoming of using software applications to control access to encrypted content is that such software can be accessed and reversed-engineered in many cases. Given that personal computers generally operate in an open environment, it can be a challenge to protect multimedia content. In some instances, software code can be moved from a protected area of memory to an unprotected memory where the code is then dissected and analyzed. It is also possible to analyze a multimedia software application residing in open memory to determine the exact memory location where encryption keys are stored. With the proper tools, it's then possible to dump blocks of memory holding these encryption keys to gain access to protected content. Thus, software approaches to protecting encrypted multimedia content still suffer from the same apparent shortcomings as unprotected content.

### SUMMARY

Briefly described, one embodiment, among others, includes a system for storing and accessing encrypted content comprising a secure hardware device coupled to a memory comprising a trusted module, wherein the hardware device is configured to receive content from a remote location, and wherein the hardware device is configured to encrypt content and generate a key for decrypting the content. The system further comprises logic stored within the memory configured to access the encrypted content, wherein the logic comprises a plurality of decryption modules and at least one decoder.

Another embodiment includes a method for delivering encrypted content comprising: receiving content from a remote location at a hardware device; encrypting the content and generating a key for decrypting the content; encrypting the key and selecting at least one of a plurality of decryption modules to receive the encrypted key, wherein the decryption modules are part of a software application stored in a memory; sending the encrypted key to one of the plurality of decryption modules, wherein the encrypted key is decrypted; and decrypting the content using the key.

Yet another embodiment includes a method for delivering encrypted content comprising: receiving from a hardware device data an encrypted key by at least one of a plurality of decryption modules, wherein the key is used to decrypt encrypted content stored at the hardware device; receiving the encrypted content from the hardware device; decrypting the encrypted key using a session key; decrypting the encrypted content using the decrypted key; and decoding the content.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of a systems and methods for storing and delivering encrypted content can be better understood with reference to the following drawings. The components in the drawings are not necessarily to scale, emphasis instead being placed upon clearly illustrating the principles disclosed herein. Moreover, in the drawings, like reference numerals designate corresponding parts throughout the several views.

FIG. 1 depicts a top-level flow diagram for an embodiment of a system for delivering encrypted content.

FIG. 2A depicts a functional block diagram for an embodiment of a system for delivering encrypted content.

FIG. 2B depicts a data flow diagram for delivering a key to a decryption module shown in FIG. 2A.

FIG. 3 depicts a functional block diagram for an alternative embodiment of a system for delivering encrypted content.

FIG. 4 depicts a functional block diagram for an alternative embodiment of a system for delivering encrypted content.

FIG. 5 depicts a flow chart for an embodiment of a method for delivering encrypted content.

FIG. 6 depicts a flow chart for an alternative embodiment of a method for delivering encrypted content.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Embodiments of systems and methods for storing and accessing encrypted multimedia content are disclosed. As explained in the background, one apparent shortcoming found in conventional approaches using software is that due to the open environment in which computers operate, software code may be moved from a protected area of memory to an unprotected memory where the code is then dissected and analyzed. It is also possible to analyze a multimedia software application residing in computer memory to determine the exact memory location where encryption keys are stored given that in many instances, access to computer memory itself is generally not restricted. With the proper tools, it's then possible to dump blocks of memory holding these encryption keys to gain access to protected content.

Certain embodiments of systems disclosed herein address these perceived shortcomings by partitioning the storage, decryption, and decoding of multimedia content between hardware and software. The combination of hardware and software is used to securely execute software code by eliminating the possibility of software tampering. In some embodiments, a system for hardware driven program execution comprises a secure hardware device coupled to open system memory, wherein the hardware device is configured to store and provide encrypted multimedia content. The system further comprises logic stored within the system memory, wherein the logic is configured to access and decode the encrypted multimedia content. It should be appreciated that for the embodiments discussed herein, the hardware device has the ability to read and modify memory in an open architecture environment. It should further be appreciated that while the logic may reside in open memory and therefore be potentially accessible, the multimedia content and the decryption key is securely stored in hardware.

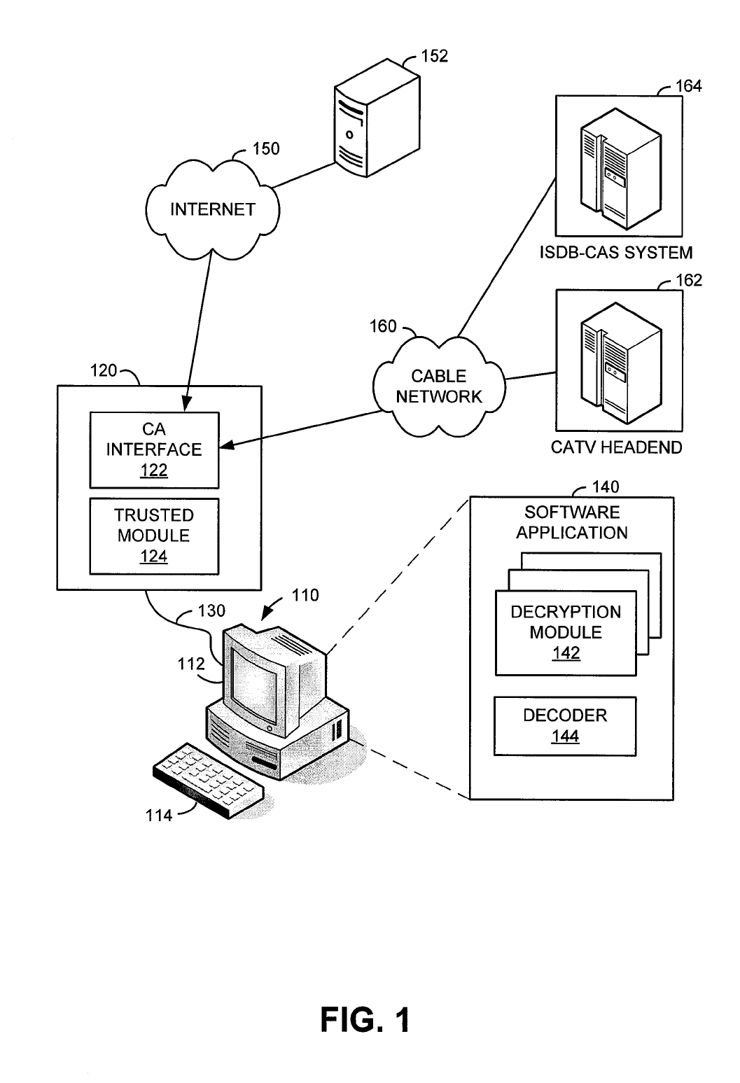

FIG. 1 depicts a top-level flow diagram for an embodiment of a system for delivering encrypted content. The system includes a secure hardware device 120 configured to store protected content. Generally, protected content refers to content which has been encrypted in order to provide conditional access to the content. The encryption and decryption process depends on a key used by algorithms to protect data. In some instances a different key may be used for the encryption and decryption processes. It should be noted that the actual encryption of data may occur in many ways and is outside the scope of this disclosure.

For some embodiments, encrypted content may be received by the hardware device 120 through a network environment 150 such as the Internet, for example. For such embodiments, another node 152 on the network 150 such as a personal computer or a server may send multimedia content in an encrypted form to the hardware device 120 over the network 150. In other embodiments, encrypted content may be received from a service provider such as a cable operator. In such embodiments, encrypted content may be sent from a cable television headend 162 located at a facility which distributes cable television signals to subscribers. Encrypted content may also be received by the hardware device 120 from an operator of an ISDB-CAS (Integrated Services Digital Broadcasting Conditional Access System) system 164 such as B-CAS (BS Conditional Access Systems Co., Ltd.). In these systems, digital media content is sent over a cable network to subscribers in encrypted form such that subscribers have conditional access to the media content.

For some embodiments, a CA (conditional access) interface 122 within the hardware device 120 receives encrypted or scrambled signals from a remote location and locally decrypts the content. For some embodiments, the CA interface 122 may simply integrate hardware (e.g., a B-CAS card) received from the operator to decrypt signals received from the service provider. Once the hardware device 120 decrypts the content, a trusted module 124 within the hardware device 120 encrypts the content once again, this time using a key generated locally within the hardware device 120. It should be noted that the content is encrypted once again by the hardware device 120 in order to maintain full flexibility in changing the decryption key on a random basis. The hardware device 120 generates a key to be used in decrypting the content and selects where to route this key.

It should be noted that the multimedia content may be encoded in any number of formats including, but not limited to, MPEG-1, MPEG-2, MPEG-4, H.264, 3GPP, 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, AVI, DV, QuickTime (QT) file, Windows Media Audio (WMA), Windows Media Video (WMV), Advanced System Format (ASF), or any number of other popular digital multimedia formats. The above exemplary formats are merely examples, and it is intended that the various embodiments of systems and methods for storing and accessing encrypted multimedia content cover any type of multimedia content in its broadest sense.

The system in FIG. 1 further comprises a software application 140 stored in the memory of a computing system 110 such as a personal computer or laptop. The computer system 110 executing the software application 140 may include a display 112 and a user input device 114, which, for example, may be a keyboard or a mouse. The software application 140 may further comprise decryption modules 142 and a decoder 144. The decryption modules 142 decrypt protected content received from the hardware device 120 using a key sent by the trusted module 124. In preferred embodiments, the software application includes multiple decryption modules 142. Upon initialization of the system, the hardware device 120 is notified of the presence of the various decryption modules 142. This may entail sending the memory addresses of each of these decryption modules 142 to the hardware device 120. In some embodiments, the hardware device 120 then randomly selects one of the decryption modules 142 to receive a key for decrypting the encrypted content. The decoder 144 decodes the multimedia content after being decrypted so that the content may be viewed on the computing system 110.

The computing system 110 can include any custom made or commercially available processor, a central processing unit (CPU), a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system 110.

The memory in which the software application 140 resides can include any one of a combination of volatile memory elements (e.g., random-access memory (RAM) such as DRAM and SRAM) and nonvolatile memory elements (e.g., ROM, hard drive, tape, CDROM, etc.). The memory typically comprises a native operating system, one or more native applications, emulation systems, or emulated applications for any of a variety of operating systems and/or emulated hardware platforms, emulated operating systems, etc. For example, the applications may include application specific software. One of ordinary skill in the art will appreciate that memory can, and typically will, comprise other components, which have been omitted for purposes of brevity.

The hardware device 120 may be coupled to the computing system 110 where the software application 140 resides through any number of common interfaces 130 including, but not limited to, a Category 5 (CAT-5) connection, an IEEE-1394 High Performance Serial Bus (Firewire) connection, a Universal Serial Bus (USB) connection, a serial connection, a parallel connection, or a wireless connection. One should note that in alternative embodiments, the hardware device 120 and the software application 140 may be integrated together on a card such as a PC card within the computing system 110. In such embodiments, the hardware device 120 may be an integrated circuit such that the hardware device 120 is coupled to a system memory (where the software application 140 resides) through a system bus.

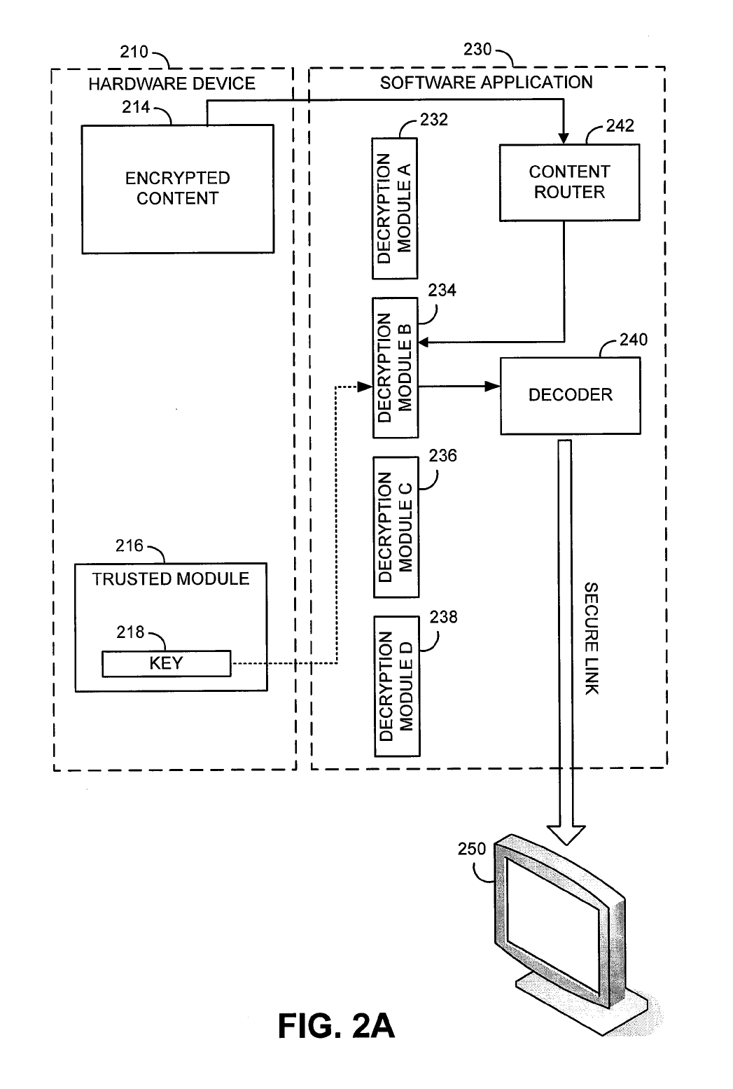

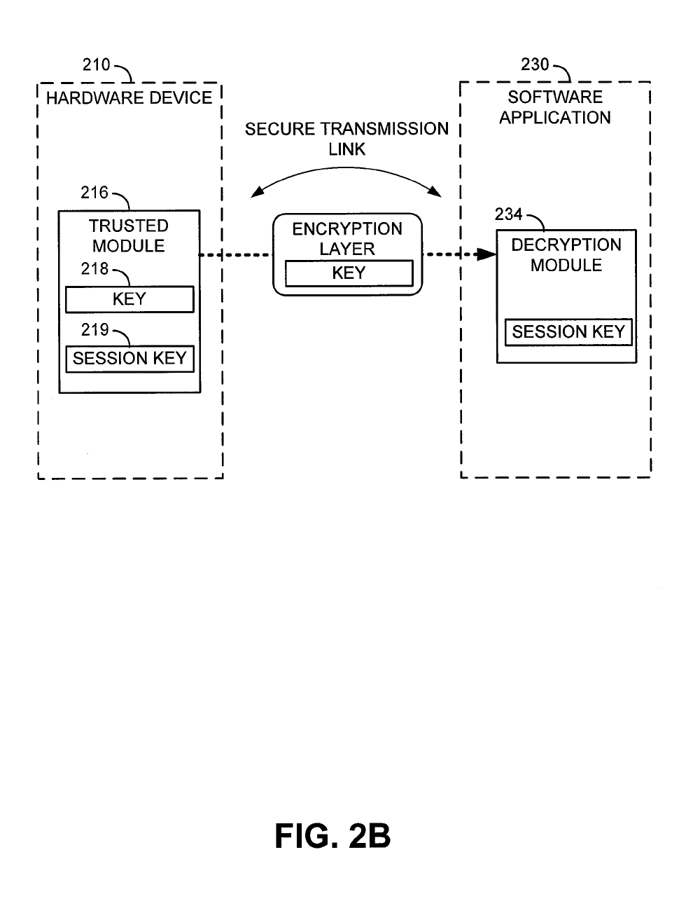

Reference is now made to FIG. 2A, which depicts a functional block diagram of an embodiment of a system for delivering encrypted content. It should be noted that some components not essential for understanding the system (by persons skilled in the art) are omitted for purposes of brevity. The system includes a hardware device 210 and a software application 230. The software application 230 generally refers to software stored in the memory of a computing system such as a PC or laptop used to view the content received by the hardware device 210. The hardware device 210 receives encrypted or scrambled content 214 from a service provider, for example, and then decrypts the received content via the CA interface 122. The hardware device 210 further comprises a trusted module 216 configured to locally encrypt the decrypted content and generate a key 218 to be later used by the software application 230 to decrypt the content received.

The trusted module 216 has the authority to select one of the multiple decryption modules 232, 234, 236, 238 located in the software application 230 to receive the key 218. It should be appreciated that multiple decryption modules 232, 234, 236, 238 are utilized for security purposes in order to make it more difficult to isolate the decryption key 218. Also, for some embodiments, the various decryption modules 232, 234, 236, 238 may each have different authority levels, which allow the modules to complete different tasks. Thus, the multiple decryption modules 232, 234, 236, 238 which have the required authority to decrypt the content currently stored on the hardware device 210 is identified by the hardware device 210 upon initialization. The trusted module 216 within the hardware device 210 then makes a selection among the decryption modules 232, 234, 236, 238 having the proper authority level. Thus, for some embodiments, the selection of the target decryption module may be made from either a subset or from all available decryption modules, making it more difficult to determine the exact location of the key. It should also be appreciated that the generated key 218 is stored in hardware so that it's not possible to simply copy or transfer a block of memory in order to retrieve the key 218. Finally, one should note that while four decryption modules are shown in FIG. 2A, different embodiments may include a different number of modules.

For some embodiments, the trusted module 216 periodically (or aperiodically in other embodiments) selects a new decryption module 232, 234, 236, 238 within the software application 230 to receive the key 218 for decrypting the content. This may be performed periodically (or aperiodically) and in a random fashion to make it more difficult to isolate the key 218 used for decrypting the secured content. One should note that this enhances security because the exact location of the key 218 is unknown at any given time.

Upon selecting a decryption module 234 and prior to actually transmitting the decryption key 218, the trusted module 216 first initiates a communication session with the target decryption module 234. It should be noted that for preferred embodiments, the trusted module 216 interfaces directly with the various decryption modules 232, 234, 236, 238. This helps to minimize the handling of the key by the software application 230, thereby reducing the possibility of accessing the key by tampering with the memory in which the software application 230 resides.

Reference is now briefly made to FIG. 2B, which depicts a data flow diagram for delivering a key to a decryption module in FIG. 2A. To protect the key 218 from unauthorized access or tampering during transmission from the hardware device 210 to the software application 230, the key 218 itself is encrypted before being sent to the target decryption module 234. A secure communication session is established by encrypting the key 218 using a pre-determined session key 219. Both the trusted module 216 and the decryption modules 232, 234, 236, 238 can access the session key 219 so that each of the decryption modules 232, 234, 236, 238 has the capability of deciphering the encrypted key. It should be appreciated by those skilled in the art that the session keys contained in the hardware device 210 and the software application 230, respectively, may or may not be the exact same key. Emphasis is placed on the fact that security is thereby maintained even if an unauthorized user attempts to monitor the transmission of data between the hardware device 210 and the software application 230.

Referring back to FIG. 2A, upon sending the encrypted key to the target decryption module 234, the hardware device 210 also sends the encrypted content 214 to a content router 242 located in the software application 230. Among other things, the content router 242 receives and forwards the encrypted content to the decryption module 234 selected to receive the key 218 for decrypting the content. Thus, in some embodiments, the content travels through a different path than the key 218 due in part because the content may be very large in size. This also allows the software application 242 to determine whether to prioritize certain content over other content for decryption/decoding. For example, in cases where only a portion of some particular content is encrypted, that content may be processed first. It should be noted that in other embodiments, the content may also be received by the decryption modules 232, 234, 236, 238 directly.

Once the content is decrypted, it is then forwarded to a decoder 240 for further processing. Depending on the digital format (e.g., MPEG-1 or MPEG-2) of the multimedia content, the proper decoding scheme is utilized. The multimedia content is then viewed on a display 250 such as a television or monitor, for example. In preferred embodiments, the decoder only outputs the decoded content to devices that have incorporated some type of restricted access mechanism such as Certified Output Protection Protocol (COPP), High-bandwidth Digital Content Protection (HDCP), Analog Content Protection (ACP), or Copy Generation Management System (CGMS). Finally, for some embodiments, the trusted module 216 may be configured to monitor the integrity of the software application 230 to detect any kind of tampering from an unauthorized user. As a non-limiting example, the trusted module 216 may monitor the software application for any suspension in code execution. As another non-limiting example, the trusted module 216 may monitor for any modification made to the memory where the software application 230 is located.

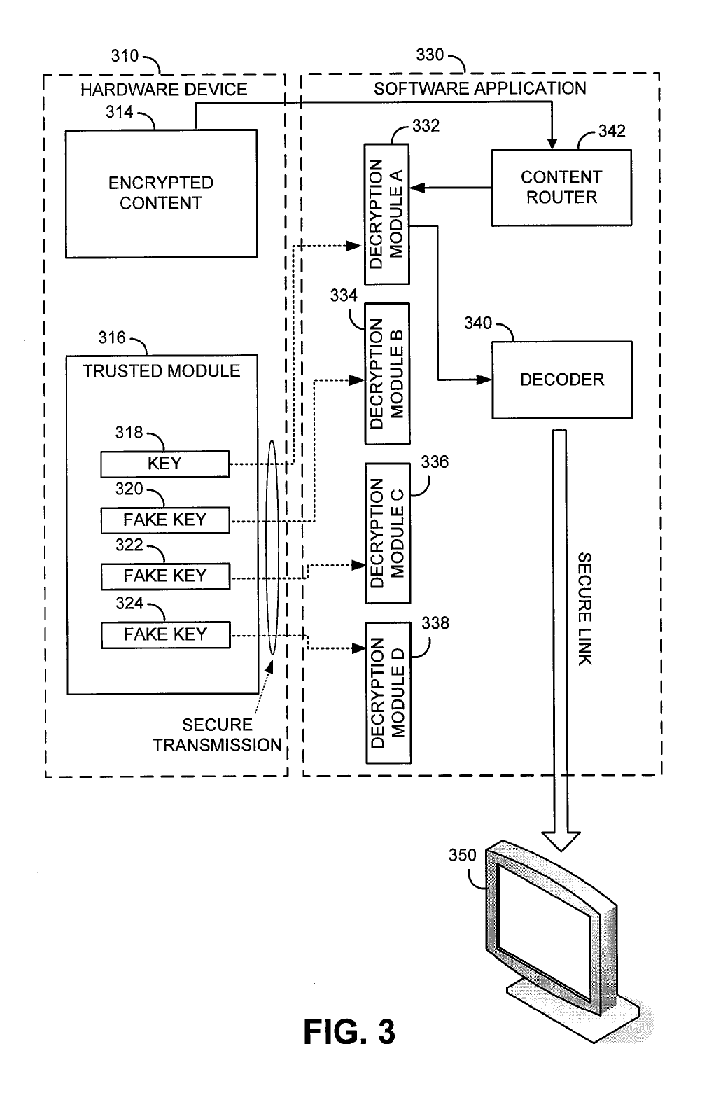

FIG. 3 depicts a functional block diagram for an alternative embodiment of a system for delivering encrypted content. As in FIG. 2, the hardware device 310 securely stores multimedia content 314 for future access. The hardware device 310 further comprises a trusted module processor 316. For the embodiment in FIG. 3, the trusted module processor 316 may contain multiple keys 318, 320, 322, 324. However, only one of the keys is a real key 318 which is capable of decrypting the secured content 314. The other “fake” keys 320, 322, 324 cannot be used to decrypt the secured content 314 and are utilized as a security measure to make it more difficult to determine which decryption module 332, 334, 336, 338 has the actual working key 318.

Upon initialization, the software application 330 again notifies the hardware device 310 of the presence of each of the decryption modules 332, 334, 336, 338. For the illustration shown, decryption module A 332 is selected by the hardware device 310 to receive the key 318 from the trusted module processor 316. “Fake” keys 320, 322, 324 are sent to the remaining decryption modules 334, 336, 338. Prior to sending both the real key 318 and the fake keys 320, 322, 324, the trusted module 316 first initiates a communication session with the decryption modules 332, 334, 336, 338. The keys 318, 320, 322, 324 are all encrypted and transmitted to the decryption modules 332, 334, 336, 338. Upon receiving the keys 318, 320, 322, 324, the decryption modules 332, 334, 336, 338 each decrypt their respective keys using a session key, as discussed for FIG. 2A. As shown in FIG. 3, the transmission of the real key and the fake keys is sent via a secure transmission link.

Upon sending the encrypted key to the target decryption module 332, the hardware device 310 also sends the encrypted content 314 to the content router 342, which then forwards the content to the authorized decryption module 332, which received the real working key 318. After decrypting the content using the received key 318, the decryption module 332 forwards the content to the decoder 340 for further processing. Depending on the digital format (e.g., MPEG-1 or MPEG-2) of the multimedia content, the proper decoding scheme is utilized. The multimedia content is then viewed on a display 350 such as a television or monitor, for example.

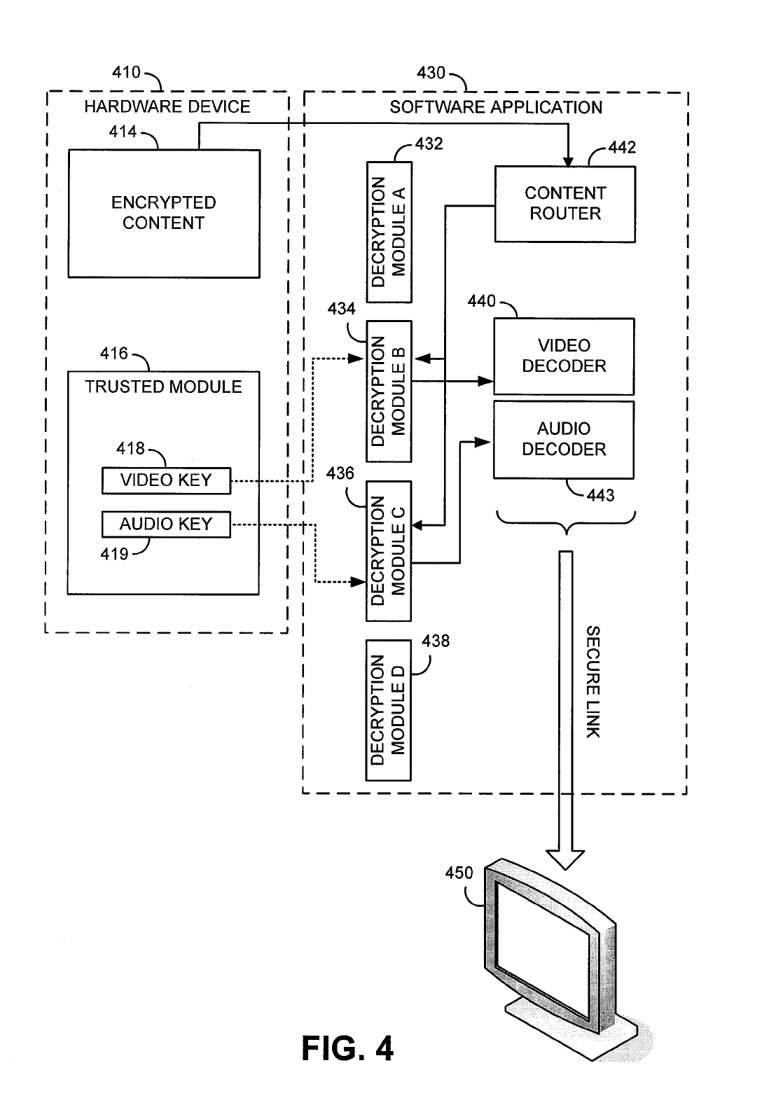

FIG. 4 depicts a functional block diagram for yet another embodiment of a system for delivering encrypted content. For the embodiment shown, the video and audio portions of the multimedia content 414 may be separately stored and encrypted to achieve an added level of protection. For some embodiments, the trusted module processor selects one or more of the decryption modules 432, 434, 436, 438 and forwards the keys 418, 419 over a secure connection. Upon receiving the encrypted keys 418, 419, the target decryption modules decrypt the encrypted keys 418, 419 using a session key. In other embodiments, separate keys may be generated for the video and audio portions of the multimedia content. In yet other embodiments, separate keys along with separate sets of decryption modules may be implemented so that the video and audio portions of the multimedia content flow through completely separate and independent decryption paths. One should note that while only one set of keys 418, 419 is shown in FIG. 4, other configurations such as the multi-key configuration illustrated in FIG. 3 (involving a real key and various “fake” keys) may be implemented as well.

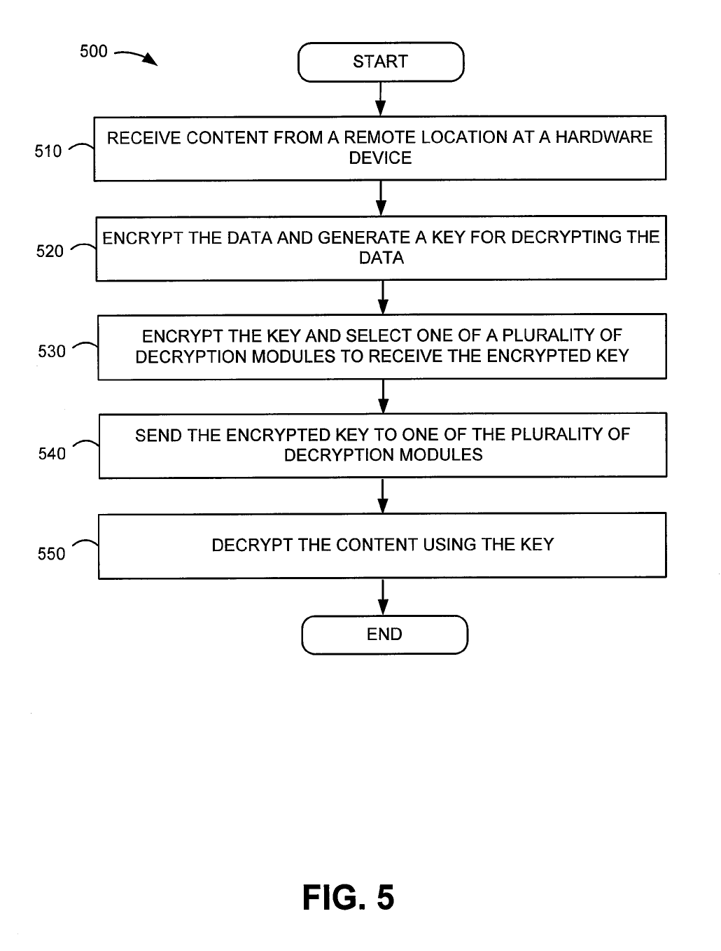

FIG. 5 depicts a flow chart for an embodiment of a method for delivering encrypted content from the perspective of the hardware device in FIGS. 2-4. The embodiment in FIG. 5 comprises receiving content from a remote location at a hardware device in block 510. Next in step 520, the content is encrypted and a corresponding key is generated for decrypting the content. For security purposes, the key is encrypted and one of the decryption modules is selected to receive the encrypted key (block 530). The key is then sent to the decryption module 540. Finally, in block 550, the content is decrypted using the key.

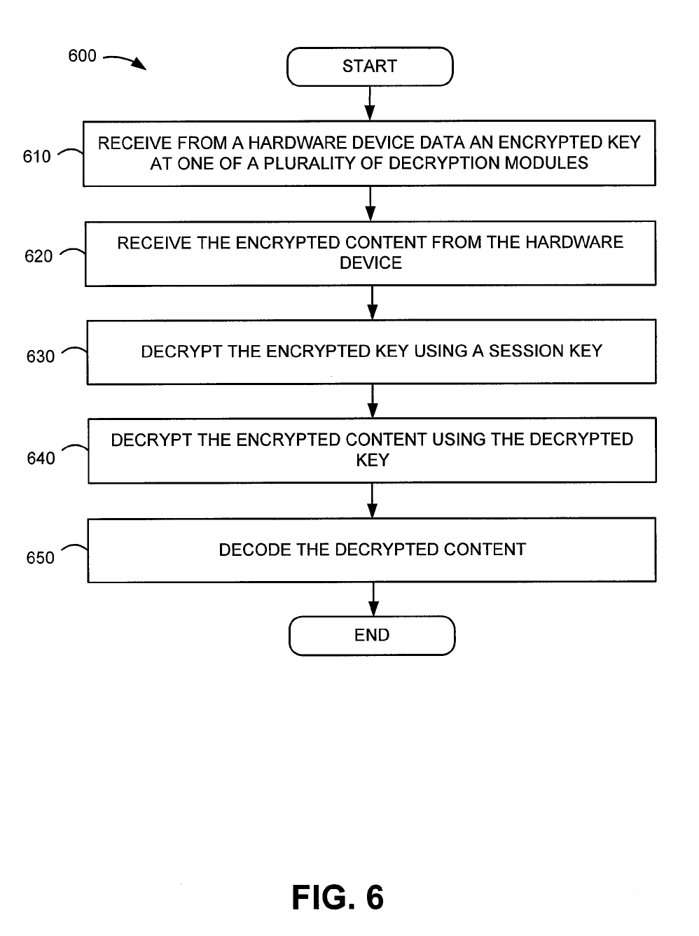

FIG. 6 depicts a flow chart for an embodiment of a method for delivering encrypted content from the perspective of the software application in FIGS. 2-4. The embodiment in FIG. 6 comprises the following. First, an encrypted key is received from a hardware device (step 610). Next, the encrypted content is received by the software application (step 620). Using a session key, the encrypted key is decrypted (step 630). In step 640, the received content is decrypted using the key. Finally, the decrypted content is decoded (block 650).

The embodiments of the present disclosure can be implemented in hardware, software, firmware, or a combination thereof. In some embodiments, the methods and systems are implemented in software or firmware that is stored in a memory and that is executed by a suitable instruction execution system. If implemented in hardware, as in an alternative embodiment, the methods and systems can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code, which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

The various embodiments of the software application described herein, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the present disclosure includes embodying the functionality of embodiments of the present disclosure in logic embodied in hardware or software-configured mediums.

Furthermore, it should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method for storing and accessing encrypted content comprising:
receiving content from a remote location at a hardware device;
encrypting the content and generating a key for decrypting the content;
encrypting the key and selecting at least one of a plurality of decryption modules to receive the encrypted key, wherein the decryption modules are part of a software application stored in a memory;
sending the encrypted key to the at least one of the plurality of decryption modules, wherein the encrypted key is decrypted; and
decrypting the content using the key.

2. The method of claim 1, wherein selecting at least one of a plurality of decryption modules is performed in a random order.

3. The method of claim 2, wherein selecting at least one of a plurality of decryption modules is performed periodically.

4. The method of claim 2, wherein selecting at least one of a plurality of decryption modules is performed aperiodically.

5. The method of claim 1, wherein sending the encrypted key to the at least one of the plurality of decryption modules further comprises sending fake keys to the remaining decryption modules.

6. The method of claim 1, wherein selecting at least one of a plurality of decryption modules comprises:
first identifying decryption modules with corresponding authority levels that match a predetermined authority level; and
selecting from among the identified decryption modules.

7. A method for storing and accessing encrypted content comprising:
receiving from a hardware device data an encrypted key by at least one of a plurality of decryption modules, wherein the key is used to decrypt encrypted content stored at the hardware device;
receiving the encrypted content from the hardware device;
decrypting the encrypted key using a session key;
decrypting the encrypted content using the decrypted key; and
decoding the content.

8. The method of claim 7, wherein receiving the key from the hardware device at one of the plurality of decryption modules is performed in a random manner.

9. The method of claim 8, wherein receiving the key from the hardware device at one of the plurality of decryption modules further comprises receiving fake keys at the remaining decryption modules.

10. The method of claim 7, wherein decrypting the encrypted content comprises separately decrypting the video and audio portions of the multimedia content.

11. A system for storing and accessing encrypted content comprising:
a secure hardware device coupled to a memory comprising a trusted module, wherein the hardware device is configured to receive content from a remote location, and wherein the hardware device is configured to encrypt content and generate a key for decrypting the content; and
logic stored within the memory configured to access the encrypted content, wherein the logic comprises a plurality of decryption modules and at least one decoder.

12. The system of claim 11, wherein the logic further comprises a content router operative to receive the encrypted content from the secure hardware device and route the encrypted content to one of the decryption modules.

13. The system of claim 11, wherein the secure hardware device further comprises a receiver module to receive multimedia content from a remote location, wherein the multimedia content is encrypted.

14. The system of claim 11, wherein the secure hardware device is further configured to select one of the plurality of decryption modules to receive a key for decrypting the content.

15. The system of claim 11, wherein the logic stored in memory further comprises separate sets of decryption modules for decrypting the video and audio portions of the encrypted content.

16. The system of claim 11, wherein the trusted module is configured to monitor for unauthorized access to the logic stored in memory.

17. The system of claim 11, wherein the at least one decoder sends the decoded content only to devices that are compliant with at least one of Certified Output Protection Protocol (COPP), High-bandwidth Digital Content Protection (HDCP), Analog Content Protection (ACP), and Copy Generation Management System (CGMS).

18. The system of claim 15, wherein the hardware device sends separate keys for decrypting the video and audio portions of the encrypted content.

19. The system of claim 14, wherein the hardware device is configured to send fake decryption keys to the remaining decryption modules.

20. The system of claim 14, wherein the hardware device is further configured to select one of the plurality of decryption modules to receive the decryption key in a random order.

21. The system of claim 14, wherein the hardware device is further configured to select one of the plurality of decryption modules to receive the decryption key on a periodic basis.

22. The system of claim 14, wherein the hardware device is further configured to select one of the plurality of decryption modules to receive the decryption key on an aperiodic basis.
